(19) United States
(12) Patent Application Publication
(10) Pub. No.: US 2011/0249860 A1
(43) Pub. Date: Oct. 13, 2011

(54) INTEGRATING AND POSITIONING METHOD FOR HIGH RESOLUTION MULTI-SATELLITE IMAGES

(76) Inventors: Liang-Chien Chen, Ping Jen (TW); Wen-Chi Chang, Tucheng City (TW); Tee-Ann Teo, Batu Pahat (MY)

(21) Appl. No.: 13/069,763

(22) Filed: Mar. 23, 2011

(30) Foreign Application Priority Data
Apr. 12, 2010 (TW) 099111232

(51) Int. Cl. G06K 9/00

(52) U.S. Cl. 382/100

(57) ABSTRACT

An integrating and positioning method for high resolution multi-satellite images is provided. In the method, direct georeferencing and a Rational Functions Model (RFM) are combined, two heterogeneous mathematical integrating and positioning adjustment models are established, so as to acquire relevant positioning parameters of the direct georeferencing and the RFM, and acquire ground coordinates of ground control points and a strip tie point, and local system errors of the ground coordinates are modified through a least-square collocation method.

### BACKGROUND OF THE INVENTION

1. Field of the Invention

The present invention relates to an integrating and positioning method for high resolution multi-satellite images, and more particularly to an integrating and positioning method for high resolution multi-satellite images suitable for homogeneous or heterogeneous data models.

2. Related Art

Satellite image geometric processing may be divided into a Rigorous Sensor Model (RSM) and a Rational Functions Model (RFM). The RSM may be further divided into a bundle method and a direct georeferencing method. Positioning relevant parameters used in the RSM and the RFM are respectively ephemeris data and Rational Polynomial Coefficients (RPCs), but the relevant parameters provided by the satellite companies not always include the two types of data, for example, an Formosat-2 satellite image only provides the ephemeris data, and an IKONOS satellite image only provides the RPC. When block adjustment needs to be performed on the two types of satellite images, the block adjustment between the heterogeneous models needs to be considered, such that the RSM and the RFM need to be integrated.

In addition to the processing of a single image, in the past documents, it is mostly emphasized that block adjustment is performed on the satellite images by using the same geometric model. For example, Grodecki and Dial propose that six IKONOS satellite images are processed by using an RFM block adjustment technique (Grodecki, J. and G. Dial, 2003. Block Adjustment of High-Resolution Satellite Image Described by Rational Polynomials, Photogrammetric Engineering & Remote Sensing, 69(1):59-68.); and Toutin proposes block bundle adjustment (Toutin, T., 2003. Block Bundle Adjustment of IKONOS In-Track Image, International Journal of Remote Sensing, 24(4):851-857.) In addition, the ephemeris data of the satellite may be transformed to the RPC (Tao, C. V., and Hu, Y., 2001. A Comprehensive Study of the Rational Function Model for Photogrammetric Processing, Photogrammetric Engineering & Remote Sensing, 67(12):1347-1357; Samadzadegan, F., Azizi, A., and Abootalebi, A., 2005. Automatic Determination of the Optimum Generic Sensor Model Based on Genetic Algorithm Concepts, Photogrammetric Engineering & Remote Sensing, 71(3):277-288), or firstly the single image is individually processed, and a plurality of images is integrated by using errors of strip tie points (conjugate points) (Chen Liangjian, Liu Jianliang, Zhang Zhi'an, Rao Jianyou, and Chen Zhejun, 2009, Method for Correcting Multi-strip Resource Satellite Images, ROC Patent Publication No. 1314712). Zhou Junyun proposes a three-dimensional positioning method for heterogeneous satellite images by using analog data, in which the Transformed RSM (TRSM) is integrated with the RFM or the Transformed RFM (TRFM) is integrated with the RSM to perform the three-dimensional positioning, and before the three-dimensional positioning calculation, the RSM and the RFM are independently completed (Zhou Junyun, 2008, “Three-dimensional Positioning Combining with Heterogeneous Satellite Image Geometric Models”, Master Thesis, Department of Civil Engineering of National Taiwan university).

### SUMMARY OF THE INVENTION

The present invention is directed to an integrating and positioning method for high resolution multi-satellite images, such that it is not necessary to consider whether positioning relevant parameters of used images are ephemeris data or Rational Polynomial Coefficients (RPCs), and block adjustment may be performed on homogeneous or heterogeneous data models by using the method.

An aspect of the present invention provides an integrating and positioning method for high resolution multi-satellite images, which includes the following step.

Satellite orbit modification parameters, refined RFM coefficients, and ground coordinates are acquired through integrating and positioning adjustment according to ephemeris data, RPCs, and control points.

According to the aspect of the present invention, the integrating and positioning adjustment includes the following steps.

a. The satellite orbit modification parameters are acquired through a direct georeferencing mathematical model according to primary orbit coordinates, observation vectors, a scale, and an image acquisition time in the ephemeris data of the satellite and the control points.

b. The refined RFM coefficients are acquired through an RFM according to functions formed by the RPCs, ground coordinates and image coordinates of the control points.

c. The ground coordinates of the control point and ground coordinates of a strip tie point are respectively acquired through a ray tracing method according to the observation vectors established according to positioning relevant parameters.

d. Direct georeferencing ground coordinate residuals are acquired through a direct georeferencing observation equation according to the satellite orbit modification parameters, the control point, the primary orbit coordinates, the image acquisition time, and the observation vectors.

e. Rational function image coordinate residuals are acquired through a rational function observation equation according to the refined RFM coefficients, image coordinates acquired according to the RPCs, and measured image coordinates.

f. Ground coordinate residuals are acquired through a pseudo equation for ground coordinates according to the ground control point and the strip tie point.

g. A satellite orbit modification parameter correction, a refined RFM coefficient correction, and a ground coordinate correction are acquired through least-square adjustment according to numerical values acquired by performing partial differential on the satellite orbit modification parameters and the ground coordinates in the direct georeferencing observation equation, numerical values acquired by performing partial differential on the refined RFM coefficients and the ground coordinates in the rational function observation equation, the direct georeferencing ground coordinate residuals, the rational function image coordinate residuals, and the ground coordinate residuals.

h. Calculation of Steps d-g is repeated in an iteration manner according to the satellite orbit modification parameter correction, the refined RFM coefficient correction, and the ground coordinate correction, until the satellite orbit modification parameter correction, the refined RFM coefficient correction, and the ground coordinate correction are converged to threshold values, so as to acquire the satellite orbit modification parameters, the refined RFM coefficients, and the ground coordinates corresponding to the satellite orbit modification parameter correction, the refined RFM coefficient correction, and the ground coordinate correction converged to the threshold values.

According to the aspect of the present invention, in Step c, solution of the ground coordinates of the ground control point gives a real height of the ground control point, and the real height is intersected with the observation vectors, so as to acquire plane coordinates of the ground control point; solution of the ground coordinates of the strip tie point firstly gives an initial elevation value, and the initial elevation value is intersected with the observation vectors, so as to acquire plane coordinates, interpolation is performed in a Digital Elevation Model (DEM) to acquire an elevation value corresponding to the plane coordinates, then the new elevation value is intersected with the observation vectors to acquire new plane coordinates, the steps are repeated until a difference between a current elevation value and a previous elevation value is smaller than a threshold value, so as to acquire plane coordinates corresponding to the elevation values having the difference being smaller than the threshold value.

According to the aspect of the present invention, the method further includes the following step.

A residual is acquired through a covariance matrix according to the ground coordinates acquired through the least-square adjustment, the ground coordinates of the control point, and the ground coordinates of the strip tie point, and the ground coordinates are modified through the residual.

The integrating and positioning method for high resolution multi-satellite images according to the present invention will be described below in detail with reference to the following embodiments, and also as set forth in applicants' Taiwanese priority application No. 099111232, filed Apr. 12, 2010, the entire contents of which are hereby incorporated herein by reference. However, these embodiments are intended to assist in understanding the present invention, but not to restrict its scope. Various possible modifications and alterations to the form and the content of any particular embodiment could be conceived of by one skilled in the art without departing from the spirit and scope of the present invention, which is intended to be defined by the appended claims.

### BRIEF DESCRIPTION OF THE DRAWINGS

The present invention will become more fully understood from the detailed description given herein below for illustration only, and thus are not limitative of the present invention, and wherein:

FIG. 1 is a flow chart of an integrating and positioning method for high resolution multi-satellite images according to the present invention;

FIG. 2 is a flow chart of solution of integrating and positioning adjustment according to the present invention;

FIG. 3 is a schematic view of a ray tracing method of a strip tie point according to the present invention;

FIG. 4A shows a satellite image of World View-1 (©Digital Globe, 2007);

FIG. 4B shows a satellite image of Quick Bird (©Digital Globe, 2005);

FIG. 4C shows a satellite image of Kompsat-2 (©KARI, 2007);

FIG. 4D shows a satellite image of Formosat-2_{—}1 (©NSPO, 2006); and

FIG. 4E shows a satellite image of Formosat-2_{—}2 (©NSPO, 2007).

### DETAILED DESCRIPTION OF THE INVENTION

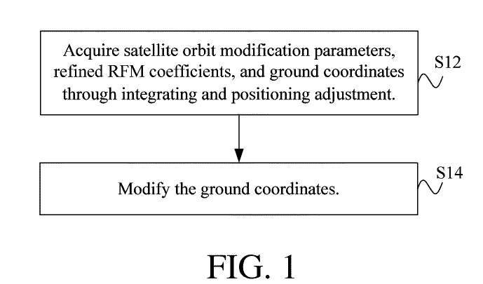

A two-stage processing manner, in which a single image is individually solved and then integrating and positioning are performed by using the tie points, is provided. In the first stage, an accuracy of ground positioning is considered, and in the second stage, geometric consistency among images is processed. In the present invention, in consideration of geometric relations of all the images, the accuracy of the ground positioning, and the geometric consistency among the images, errors are reasonably distributed through a least-square adjustment technique, and then local system errors are eliminated by using a least-square collocation method. FIG. 1 is a flow chart of an integrating and positioning method for high resolution multi-satellite images according to the present invention.

In Step S12 of FIG. 1, a satellite orbit modification parameter correction, a refined RFM coefficient correction, and a ground coordinate correction are acquired. In order to acquire the satellite orbit modification parameter correction, the refined RFM coefficient correction, and the ground coordinate correction, satellite orbit modification parameters, refined RFM coefficients, and ground coordinates are acquired through integrating and positioning adjustment according to ephemeris data, RPCs, and control points.

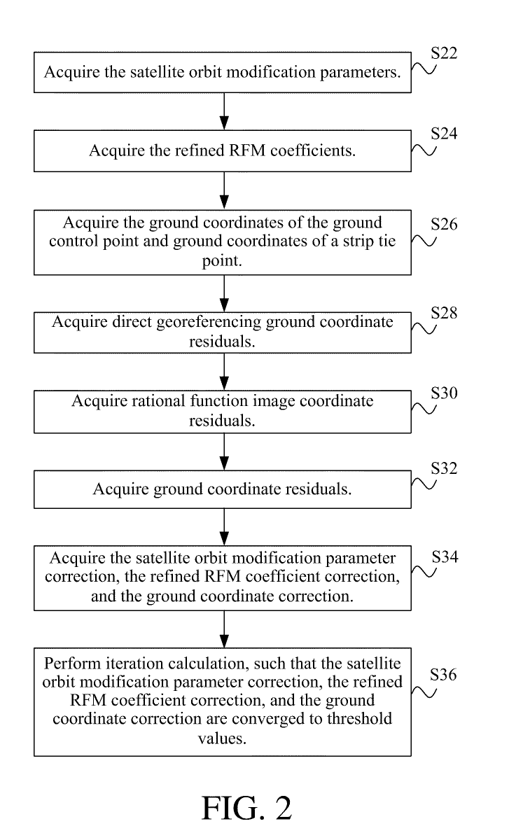

FIG. 2 is a flow chart of solution of the integrating and positioning adjustment according to the present invention. In FIG. 2, a process of acquiring the satellite orbit modification parameters, the refined RFM coefficients, and the ground coordinates through the integrating and positioning adjustment is illustrated.

In Step S22 of FIG. 2, the satellite orbit modification parameters are acquired. The satellite orbit modification parameters are acquired through a direct georeferencing mathematical model according to the ephemeris data of the satellite (including primary orbit coordinates, observation vectors, a scale, and an image acquisition time of the satellite) and the control points. The direct georeferencing mathematical model is as shown in the following:

Xᵢ=x₀+a₀+a₁t+Sᵢu_{Xi}

Yᵢ=y₀+b₀+b₁t+Sᵢu_{Yi}

Zᵢ=z₀+c₀+c₁t+Sᵢu_{Zi}

where

a₀, a₁, b₀, b₁, c₀, c₁ represent satellite orbit modification parameters,

Xᵢ, Yᵢ, Zᵢ represent ground coordinates of the control point,

x₀, y₀, z₀ represent primary orbit coordinates formed by the ephemeris data,

Sᵢ represents scale,

t represents time, and

u_{Xi}, u_{Yi}, u_{Zi} represent observation vectors.

In Step S24 of FIG. 2, the refined RFM coefficients are acquired. The refined RFM coefficients are acquired through an RFM according to functions formed by the RPCs, ground coordinates and image coordinates of the control point. The refined RFM is as shown in the following:

$$s = {A}_{0} + {A}_{1} \cdot {f}_{1} ( \frac{{Num}_{s} ( P , L , H )}{{Den}_{s} ( P , L , H )} ) + {A}_{2} \cdot {f}_{2} ( \frac{{Num}_{l} ( P , L , H )}{{Den}_{l} ( P , L , H )} )$$

$$l = {B}_{0} + {B}_{1} \cdot {f}_{1} ( \frac{{Num}_{s} ( P , L , H )}{{Den}_{s} ( P , L , H )} ) + {B}_{2} \cdot {f}_{2} ( \frac{{Num}_{l} ( P , L , H )}{{Den}_{l} ( P , L , H )} )$$

where

A₀, A₁, A₂, B₀, B₁, B₂ represent refined RFM coefficients,

P, L, H represent normalized ground coordinates of the control point,

Num, Den represent functions formed by the RPCs, and

s, l represent image coordinates of the control point.

In Step S26 of FIG. 2, the ground coordinates of the control point and ground coordinates of a strip tie point are acquired. In order to acquire the ground coordinates of the control point, a ground real height of the ground control point is given through a ray tracing method, and the ground real height is intersected with the observation vectors established according to positioning relevant parameters, so as to acquire plane coordinates.

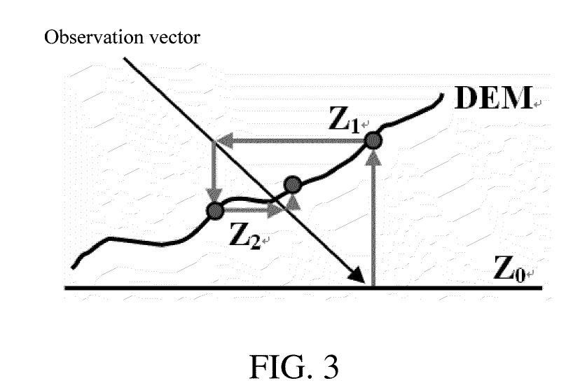

FIG. 3 is a schematic view of the ray tracing method of the strip tie point according to the present invention. Referring to FIG. 2, in order to acquire the ground coordinates of the strip tie point of Step S26, an initial elevation value Z₀ is given, and the initial elevation value Z₀ is intersected with the observation vectors, so as to acquire plane coordinates, interpolation is performed in a DEM to acquire an elevation value Z₁ corresponding to the plane coordinates, then the new elevation value Z₁ (and Z₂ . . . ) is intersected with the observation vectors to acquire new plane coordinates, the steps are repeated until a difference between a current elevation value and a previous elevation value is smaller than a threshold value, so as to acquire plane coordinates corresponding to the elevation values having the difference being smaller than the threshold value.

In Step S28 of FIG. 2, direct georeferencing ground coordinate residuals are acquired. The direct georeferencing ground coordinate residuals are acquired through a direct georeferencing observation equation according to the satellite orbit modification parameters, the control point, the primary orbit coordinates, the image acquisition time and the observation vectors. The direct georeferencing observation equation is as shown in the following:

D₁=vₓᵢ=(x₀+a₀+a₁·t−Xᵢ)/(z₀+c₀+c₁·t−Zᵢ)−u_{Xi}/u_{Zi}

D₂=v_{yi}=(y₀+b₀+b₁·t−Yᵢ)/(z₀+c₀+c₁·t−Zᵢ)−u_{Yi}/u_{Zi}

where,

vₓᵢ, v_{yi} represent direct georeferencing ground coordinate residuals.

In Step S30 of FIG. 2, rational function image coordinate residuals are acquired. The rational function image coordinate residuals are acquired through a rational function observation equation according to the refined RFM coefficients, image coordinates acquired according to the RPCs and measured image coordinates. The rational function observation equation is as shown in the following:

R₁=vₛᵢ=A₀+A₁·s_{rfm}+A₂·i_{rfm}−sᵢ

R₂=vₗᵢ=B₀+B₁·s_{rfm}+B₂·l_{rfm}−lᵢ

where,

s_{rfm}, l_{rfm} represent image coordinates acquired according to the RPCs,

sᵢ, lᵢ represent measured image coordinates, and

vₛᵢ, vᵢᵢ represent rational function image coordinate residuals.

In Step S32 of FIG. 2, ground coordinate residuals are acquired. The ground coordinate residuals are acquired through a pseudo equation for ground coordinates according to the ground control point and the strip tie point. The pseudo equation for ground coordinates is as shown in the following:

G₁=v_{φ}=φ⁰−φ⁰⁰Q

G₂=v_{λ}=λ⁰−λ⁰⁰

G₃=vₕ=h⁰−h⁰⁰

where,

φ⁰, λ⁰, h⁰ represent ground coordinates of the control point and ground coordinates of the strip tie point calculated through the ray tracing method,

φ⁰⁰, λ⁰⁰, h⁰⁰ represent observed values of the ground coordinates of the control point and average values of the ground coordinates of the strip tie point, and

v_{φ}, v_{λ}, vₕ represent ground coordinate residuals.

In Step S34 of FIG. 2, the satellite orbit modification parameter correction, the refined RFM coefficient correction, and the ground coordinate correction are acquired. The satellite orbit modification parameter correction, the refined RFM coefficient correction, and the ground coordinate correction are acquired through least-square adjustment according to numerical values acquired by performing partial differential on the satellite orbit modification parameters a₀, a₁, b₀, b₁, c₀, c₁ and the ground coordinates in the direct georeferencing observation equation, numerical values acquired by performing partial differential on the refined RFM coefficients A₀, A₁, A₂, B₀, B₁, B₂ and the ground coordinates in the rational function observation equation, the direct georeferencing ground coordinate residuals, the rational function image coordinate residuals and the ground coordinate residuals. The least-square adjustment is as shown in the following:

$$[ \begin{matrix}{V}_{D} \\ {V}_{R} \\ {V}_{G}\end{matrix} ] = [ \begin{matrix}{\dot{B}}_{D} & 0 & {\ddot{B}}_{D} \\ 0 & {\dot{B}}_{R} & {\ddot{B}}_{R} \\ 0 & 0 & - I\end{matrix} ] [ \begin{matrix}{\dot{Δ}}_{D} \\ {\dot{Δ}}_{R} \\ {\ddot{Δ}}_{G}\end{matrix} ] - [ \begin{matrix}{ɛ}_{D} \\ {ɛ}_{R} \\ {ɛ}_{G}\end{matrix} ]$$

or V̅= B̅Δ− C̅ for short,

where,

V̅ represents residual matrix, which is calculated by using B̅, C̅, and solved Δ according to V̅= B̅Δ− C̅,

B̅ represents design matrix, where \dot{B}_{D} represents the numerical value acquired by performing the partial differential on the satellite orbit modification parameters a₀, a₁, b₀, b₁, c₀, c₁ in the direct georeferencing observation equation, \ddot{B}_{D} represents the numerical value acquired by performing the partial differential on the ground coordinates in the direct georeferencing observation equation, \dot{B}_{R} represents the numerical value acquired by performing the partial differential on the refined RFM coefficients A₀, A₁, A₂, B₀, B₁, B₂ in the rational function observation equation, \ddot{B}_{R} represents the numerical value acquired by performing the partial differential on the ground coordinates in the rational function observation equation,

Δ represents unknown matrix, where \dot{Δ}_{D} is the satellite orbit modification parameter correction, \dot{Δ}_{R} is the refined RFM coefficient correction, and \ddot{Δ}_{G} is the ground coordinate correction, and

C̅ represents observation matrix, where ε_{D} is the residual value of vₓᵢ, v_{yi} etc., ε_{R} is the residual value of vₛᵢ, vᵢᵢ etc., and ε_{G} is the residual value of v_{φ}, v_{λ}, vₕ etc.

Resolutions of different satellite images are different, so a weight of each correction in the unknown matrix is adjusted in cooperation with a corresponding weight matrix W. The weight matrix W is as shown in the following:

$$W = [ \begin{matrix}{W}_{D} & 0 & 0 \\ 0 & {W}_{R} & 0 \\ 0 & 0 & {W}_{G}\end{matrix} ]$$

where,

W_{D} represents weight of the satellite orbit modification parameter correction,

W_{R} represents weight of the refined RFM coefficient correction, and

W_{G} represents weight of the ground coordinate correction.

According to the least-square method, the correction of each parameter is:

Δ=( B̅^{T} W̅B̅)⁻¹( B̅^{T} W̅C̅)

In Step S36 of FIG. 2, iteration calculation is performed, such that the satellite orbit modification parameter correction \dot{Δ}_{D}, the refined RFM coefficient correction \dot{Δ}_{R}, and the ground coordinate correction \ddot{Δ}_{G} are converged to threshold values. According to the satellite orbit modification parameter correction \dot{Δ}_{D}, the refined RFM coefficient correction \dot{Δ}_{R}, and the ground coordinate correction \ddot{Δ}_{G}, calculation of Steps S28-S34 is repeated in the iteration manner based on the equations of Steps S28-S34, that is, the satellite orbit modification parameter correction \dot{Δ}_{D}, the refined RFM coefficient correction \dot{Δ}_{R} and the ground coordinate correction \ddot{Δ}_{G} acquired in the previous time are respectively added to the corresponding parameters (for example, the satellite orbit modification parameters a₀, a₁, b₀, b₁, c₀, c₁ and the refined RFM coefficients A₀, A₁, A₂, B₀, B₁, B₂), and then are substituted into the direct georeferencing observation equation, the rational function observation equation, and the pseudo equation for ground coordinates, so as to acquire the direct georeferencing ground coordinate residuals vₓᵢ, v_{yi} the rational function image coordinate residuals vₛᵢ, vₗᵢ, and the ground coordinate residuals v_{φ}, v_{λ}, vₕ, and the direct georeferencing ground coordinate residuals v_{φ}, v_{λ}, vₕ the rational function image coordinate residuals vₛᵢ, vᵢᵢ, and the ground coordinate residuals v_{φ}, v_{λ}, vₕ, acquired this time are substituted into the least-square adjustment, so as to acquire a new satellite orbit modification parameter correction \dot{Δ}_{D}, a new refined RFM coefficient correction \dot{Δ}_{R}, and a new ground coordinate correction \ddot{Δ}_{G}, the steps are repeated, until the satellite orbit modification parameter correction \dot{Δ}_{D}, the refined RFM coefficient correction \dot{Δ}_{R}, and the ground coordinate correction \ddot{Δ}_{G} are converged to the threshold values. In this manner, the satellite orbit modification parameters and the refined RFM coefficients corresponding to the corrections converged to the threshold values are acquired.

Referring to FIG. 1 again, in Step S14 of FIG. 1, the ground coordinates are modified. In this embodiment, it is assumed that three-dimensional directions of a ground position are independent, the ground coordinates are modified through three one-dimensional least-square collocations, and the ground control point and the strip tie point are used as reference points. The mathematical expression is as shown in the following:

ρₖ=σₖ·[Σₖ]⁻¹·vₖ

where,

k represents x, y, or z direction,

ρₖ represents correction in the k direction,

σₖ represents covariance of the unknown point (that is, check point) and each reference point in the k direction,

Σₖ represents covariance matrix between reference points in the k direction, and

vₖ represents residual of each reference point in the k direction.

Functions forming the covariance matrix are as shown in the following:

$$Covariance = \{ \begin{matrix}( 1 - {R}_{n} ) \cdot {μ}_{k} \cdot {e}^{- {( G \cdot \frac{d }{{d}_{max}} )}^{2}} , & if d \neq 0 \\ {μ}_{k} , & if d = 0\end{matrix}$$

where,

Rₙ represents ratio of a noise variance to a observation variance,

μₖ represents residual variance in the k direction,

G represents weight, and

d, dₘₐₓ represent distance and maximal distance between points (unit: picture element).

The residual in the k direction is acquired through the mathematical expressions, and the ground coordinates of the control point or the strip tie point in the k direction is modified according to the residual.

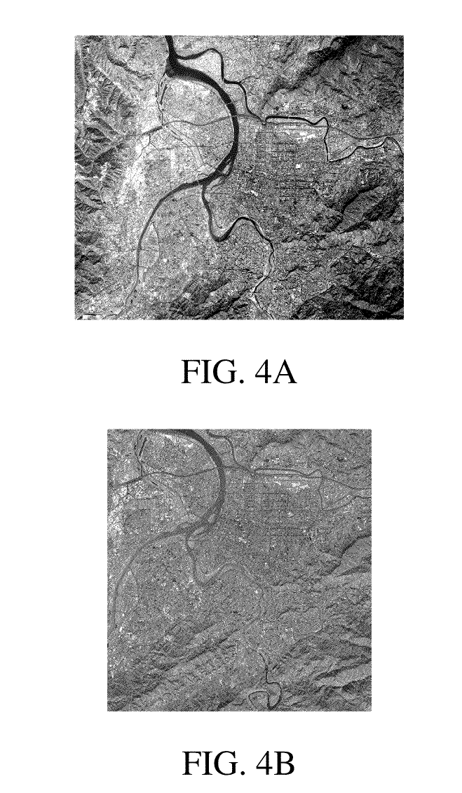

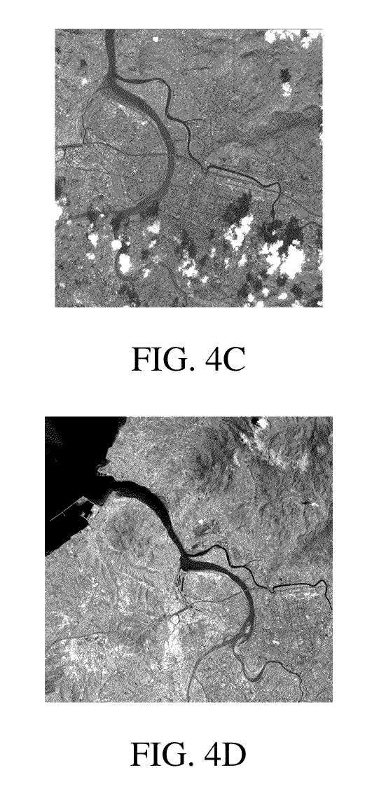

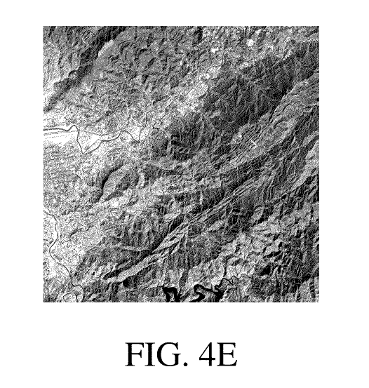

Test images used in this embodiment include a satellite image of World View-1 (©Digital Globe, 2007) in FIG. 4A, a satellite image of QuickBird (©Digital Globe, 2005) in FIG. 4B, a satellite image of Kompsat-2 (©KARI, 2007) in FIG. 4C, a satellite image of Formosat-2_{—}1 (©NSPO, 2006) in FIG. 4D, and a satellite image of Formosat-2_{—}2 (©NSPO, 2007) in FIG. 4E etc. The special resolution of DEM required in the test is 5 meters, and in an error analysis, the single image processing and the integrating and positioning adjustment provided in the present invention are compared, in which analysis items include a ground three-dimensional positioning error and an image geometric consistency.

(1) For the ground three-dimensional positioning error, the result analysis is as shown in Table 1. For the WorldView-1, the QuickBird, and the Kompsat-2 having the higher resolution, the result difference between the single image processing and the integrating and positioning adjustment is not large, but for the Formosat-2 image having the lower resolution, the modification is quite distinct, which is approximately improved by 3.5 meters.

TABLE 1
Ground three-dimensional positioning analysis

| | | | Integrating and | |
|---|---|---|---|---|
| | | Single image | positioning | |
| | | processing | adjustment | Improvement |
| WorldView-1 | E | 0.87 | 0.90 | −0.03 |
| | N | 0.64 | 0.57 | 0.06 |
| QuickBird | E | 0.50 | 0.47 | 0.03 |
| | N | 0.62 | 0.48 | 0.14 |
| Kompsat-2 | E | 0.94 | 1.04 | −0.11 |
| | N | 1.83 | 2.02 | −0.19 |
| Formosat-2_1 | E | 6.15 | 2.65 | 3.50 |
| | N | 2.36 | 1.27 | 1.08 |
| Formosat-2_2 | E | 6.92 | 3.69 | 3.24 |
| | N | 2.65 | 2.11 | 0.54 |

Unit: Meter

(2) For the image geometric consistency, the result analysis is as shown in Table 2. It is found that through the processing manner of the present invention, the image geometric consistency is effectively improved. The WorldView-1 image is approximately improved by 0.5 meters, the Kompsat-2 image is approximately improved by 1 meter, and the two Formosat-2 images are respectively improved by 6.7 meters and 4 meters.

TABLE 2
Image geometric consistency analysis

| | | | Integrating and | |
|---|---|---|---|---|
| | | Single image | positioning | |
| | | processing | adjustment | Improvement |
| WorldView-1 | E | 0.52 | 0.51 | 0.01 |
| | N | 0.98 | 0.47 | 0.52 |
| QuickBird | E | 0.47 | 0.42 | 0.05 |
| | N | 0.53 | 0.50 | 0.03 |
| Kompsat-2 | E | 1.64 | 1.57 | 0.08 |
| | N | 2.96 | 1.99 | 0.97 |
| Formosat-2_1 | E | 8.90 | 2.20 | 6.70 |
| | N | 6.37 | 3.13 | 3.23 |
| Formosat-2_2 | E | 7.08 | 3.09 | 3.99 |
| | N | 2.53 | 2.42 | 0.10 |

Unit: Meter

The present invention provides an integrating and positioning method for high resolution multi-satellite images, in which it is not necessary to consider whether positioning relevant parameters of used images are ephemeris data or RPCs, and block adjustment may be performed on homogeneous or heterogeneous data models by using the method.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An integrating and positioning method for high resolution multi-satellite images, comprising:
acquiring satellite orbit modification parameters, refined Rational Functions Model (RFM) coefficients, and ground coordinates through integrating and positioning adjustment according to ephemeris data, Rational Polynomial Coefficients (RPCs), and control points,
wherein the integrating and positioning adjustment comprises:
a. acquiring the satellite orbit modification parameters through a direct georeferencing mathematical model according to primary orbit coordinates, observation vectors, a scale, and an image acquisition time in the ephemeris data of a satellite and the control points;
b. acquiring the refined RFM coefficients through an RFM according to functions formed by the RPCs, ground coordinates and image coordinates of the control points;
c. respectively acquiring the ground coordinates of the control points and ground coordinates of a strip tie point through a ray tracing method according to the observation vectors established according to positioning relevant parameters;
d. acquiring direct georeferencing ground coordinate residuals through a direct georeferencing observation equation according to the satellite orbit modification parameters, the control points, the primary orbit coordinates, the image acquisition time, and the observation vectors;
e. acquiring rational function image coordinate residuals through a rational function observation equation according to the refined RFM coefficients, image coordinates acquired according to the RPCs, and measured image coordinates;
f. acquiring ground coordinate residuals through a pseudo equation for ground coordinates according to the ground control points and the strip tie point;
g. acquiring a satellite orbit modification parameter correction, a refined RFM coefficient correction, and a ground coordinate correction through least-square adjustment according to numerical values acquired by performing partial differential on the satellite orbit modification parameters and the ground coordinates in the direct georeferencing observation equation, numerical values acquired by performing partial differential on the refined RFM coefficients and the ground coordinates in the rational function observation equation, the direct georeferencing ground coordinate residuals, the rational function image coordinate residuals, and the ground coordinate residuals; and
h. repeating calculation of Steps d-g in an iteration manner according to the satellite orbit modification parameter correction, the refined RFM coefficient correction, and the ground coordinate correction, until the satellite orbit modification parameter correction, the refined RFM coefficient correction, and the ground coordinate correction are converged to threshold values, so as to acquire the satellite orbit modification parameters, the refined RFM coefficients, and the ground coordinates corresponding to the satellite orbit modification parameter correction, the refined RFM coefficient correction, and the ground coordinate correction converged to the threshold values.

2. The method according to claim 1, wherein in Step c, solution of the ground coordinates of the ground control points gives a real height of the ground control points, and the real height is intersected with the observation vectors, so as to acquire plane coordinates of the ground control points; solution of the ground coordinates of the strip tie point gives an initial elevation value, and the initial elevation value is intersected with the observation vectors, so as to acquire plane coordinates, interpolation is performed in a Digital Elevation Model (DEM) to acquire an elevation value corresponding to the plane coordinates, then the new elevation value is intersected with the observation vectors to acquire new plane coordinates, the steps are repeated until a difference between a current elevation value and a previous elevation value is smaller than a threshold value, so as to acquire plane coordinates corresponding to the elevation values having the difference being smaller than the threshold value.

3. The method according to claim 1, further comprising:
acquiring a residual through a covariance matrix according to the ground coordinates acquired through the least-square adjustment, the ground coordinates of the control points, and the ground coordinates of the strip tie point, and modifying the ground coordinates through the residual.
